(19) United States
(12) Patent Application Publication
(10) Pub. No.: US 2022/0057117 A1
(43) Pub. Date: Feb. 24, 2022

(54) LIQUID AMMONIA, SODIUM NITRATE AND LITHIUM BROMIDE DIFFUSION REFRIGERATION SYSTEM

(71) Applicant: Wuyi University, Jiangmen City (CN)

(72) Inventor: Min WU, Jiangmen City (CN)

(21) Appl. No.: 17/320,474

(22) Filed: May 14, 2021

(30) Foreign Application Priority Data
Aug. 21, 2020 (CN) 202010847605X

(51) Int. Cl. F25B 15/06; C09K 5/10; C09K 5/04; F25B 15/02; F25B 37/00

(52) U.S. Cl. CPC F25B 15/06; C09K 5/10; C09K 2205/132; F25B 15/025; F25B 37/00; C09K 5/047

(57) ABSTRACT

Disclosed is a refrigeration system, including: a generator having a liquid storage cavity for containing a liquid ammonia and sodium nitrate solution, a heat source being connected to the generator and an exhaust pipe being arranged at an upper end of the generator; a condenser having a condensation cavity, an inlet of the condensation cavity being communicated with the exhaust pipe; an evaporator having an evaporation cavity, an inlet of the evaporation cavity being communicated with an outlet of the condensation cavity through a liquid inlet pipe; an expansion valve arranged on the liquid inlet pipe; an absorber located below the generator and having an absorption cavity for containing a sodium nitrate solution, an upper part of the absorption cavity being communicated with an outlet of the evaporation cavity through a gas pipe.

### CROSS-REFERENCE TO RELATED APPLICATIONS

This application claims priority to Chinese patent application No. 202010847605.X, filed Aug. 21, 2020. The content of which is incorporated herein by reference in its entirety.

### TECHNICAL FIELD

The present invention relates to the technical field of refrigeration, and more particularly, to a sodium nitrate-liquid ammonia diffusion-absorption refrigeration system.

### BACKGROUND

Currently, there are several common absorption refrigeration methods, for example, ammonia-water absorption refrigeration and ammonia-hydrogen-water absorption-diffusion refrigeration. Although a refrigeration temperature of the ammonia-water absorption refrigeration can reach tens of degrees below zero, since ammonia and water, which tend to evaporate during heating, are used as a working pair for refrigeration, a rectification device is required, and the refrigeration efficiency is reduced. In contrast, in the ammonia-hydrogen-water diffusion refrigeration, a diffusing gas, i.e., hydrogen, is added as a balance gas based on ammonia-water absorption refrigeration. Because ammonia and water are still used as a working pair, the resulting disadvantage is similar to that of the ammonia-water absorption refrigeration. The COP is generally around 0.4, which is difficult to meet a large refrigeration demand.

### SUMMARY

In order to address at least one of the technical problems in the existing technology, the present invention proposes a refrigeration system, which uses sodium nitrate and liquid ammonia as a working pair for refrigeration to simplify equipment and reduce requirements.

A refrigeration system according to an embodiment of the present invention includes: a generator having a liquid storage cavity for containing a liquid ammonia and sodium nitrate solution, wherein a heat source is connected to the generator, and an exhaust pipe is arranged at an upper end of the generator; a condenser having a condensation cavity, wherein an inlet of the condensation cavity is communicated with the exhaust pipe; an evaporator having an evaporation cavity, wherein an inlet of the evaporation cavity is communicated with an outlet of the condensation cavity through a liquid inlet pipe; an expansion valve arranged on the liquid inlet pipe; an absorber located below the generator and having an absorption cavity for containing a sodium nitrate solution, wherein an upper part of the absorption cavity is communicated with an outlet of the evaporation cavity through a gas pipe, the absorber is provided with a liquid delivery pipe and a reflux pipe, an upper end of the liquid delivery pipe is communicated with the liquid storage cavity and a lower end of the liquid delivery pipe is communicated with the upper part of the absorption cavity, an upper end of the reflux pipe is communicated with the liquid storage cavity and a lower end of the reflux pipe extends to a lower part of the absorption cavity, and a reflux pump is arranged on the reflux pipe; and a lithium bromide-water refrigerating machine, wherein a first cold water pipe and a second cold water pipe are arranged at a cold water output end of the lithium bromide-water refrigerating machine, the first cold water pipe being connected to the condenser to cool a gas in the condensation cavity, and the second cold water pipe being connected to the absorber to cool the sodium nitrate solution in the absorption cavity.

The refrigeration system according to the embodiment of the present invention at least has the following beneficial effects. The liquid ammonia-sodium nitrate diffusion refrigeration device uses sodium nitrate as an absorbent and liquid ammonia as a refrigerant, where sodium nitrate is a kind of salt with a boiling point of 380° C., which is very different from a boiling point of liquid ammonia, such that rectification equipment is eliminated, the system is simplified, and the cost is reduced. The constant-pressure specific heat is relatively large, which is beneficial to reduce a heat exchange area, miniaturize the equipment and reduce the occupied space. Liquid ammonia-sodium nitrate is an ideal working pair for absorption and refrigeration, and its COP can also meet higher requirements. The refrigeration can reach a temperature below zero to meet the larger refrigeration demand and provide a wider range of applications.

According to some embodiments of the present invention, the heat source is a hot water pipeline has a temperature of 110° C. or higher.

According to some embodiments of the present invention, a pressure pump is arranged on the hot water pipeline.

According to some embodiments of the present invention, the first cold water pipe is provided with a coil in the condensation cavity, and the coil and the liquid inlet pipe exchange heat in the condensation cavity.

According to some embodiments of the present invention, the expansion valve is an electronic expansion valve.

According to some embodiments of the present invention, the liquid delivery pipe and the reflux pipe are arranged at two ends of the absorber separately.

According to some embodiments of the present invention, one end of the exhaust pipe connected to the condensation cavity is configured to be bent upward.

According to some embodiments of the present invention, a middle part of the gas pipe is configured to bulge upward.

According to some embodiments of the present invention, the lithium bromide-water refrigerating machine includes a second generator, which is connected to the heat source to realize heating.

According to some embodiments of the present invention, cold water output from the lithium bromide-water refrigerating machine has a temperature of 7° C. to 9° C.

The additional aspects and advantages of the present invention will be partly given in the following description, and partly will become obvious from the following description, or be understood through the practice of the present invention.

### BRIEF DESCRIPTION OF THE DRAWINGS

The above and/or additional aspects and advantages of the present invention will become obvious and easy to understand from the description of the embodiments in conjunction with the following accompanying drawings, in which:

FIG. 1 is a schematic structural diagram of a refrigeration system according to some embodiments of the present invention.

### DETAILED DESCRIPTION

A description will be made in detail to the embodiments of the present invention, examples of which are illustrated in the accompanying drawings. The reference numerals which are the same or similar throughout the accompanying drawings represent the same or similar components or components with the same or similar functions. The embodiments described below with reference to the accompanying drawings are exemplary, and are only intended to explain the present invention, rather than being construed as limitations to the present invention.

In the description of the present invention, it should be understood that the orientation or state relations indicated via terms of “upper”, “lower”, “front”, “rear”, “left”, “right”, and the like, that are involve the description of orientations, are based on orientation or the state relations shown in the drawings only to describe the present invention conveniently and simplify the description, but not indicate or imply that referred devices or elements must have particular orientations or be constructed and operated with the particular orientation, so that they cannot be construed as limiting of the present invention.

In the description of the present invention, the terms “first” and “second” are, if any, only used for distinguishing the technical features, and cannot be understood as indicating or implying the relative importance, or implicitly specifying the number of the indicated technical features, or specifying the precedence relationship of the indicated technical features.

In the description of the present invention, unless otherwise clearly defined, terms such as “defined”, “arranged”, “mounted”, and “connected” should be understood in a broad sense. Those skilled in the art can understand the specific meaning of the above terms in the present invention in accordance with specific content of the technical solutions.

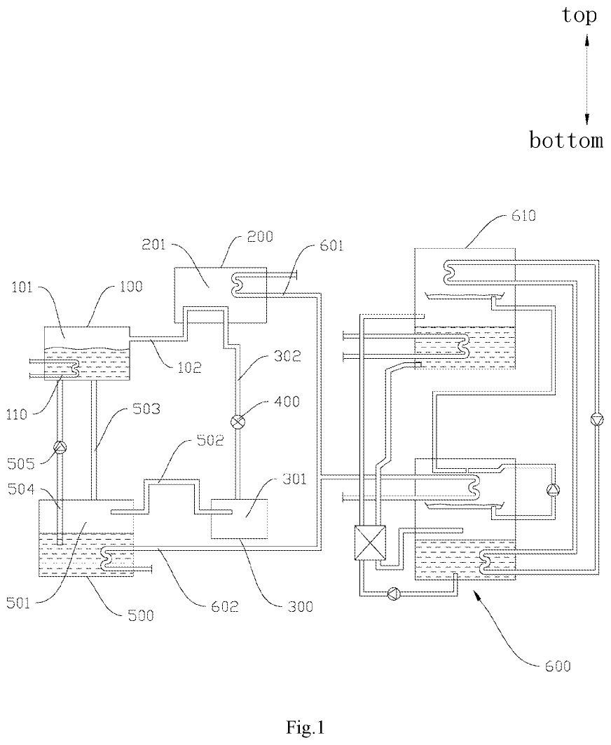

Referring to FIG. 1, embodiments of the present invention provide a refrigeration system. The refrigeration system includes a generator 100, a condenser 200, an evaporator 300, an expansion valve 400, an absorber 500 and a lithium bromide-water refrigerating machine 600. The generator 100 has a liquid storage cavity 101 for containing a liquid ammonia and sodium nitrate solution, a heat source 110 is connected to the generator 100, and an exhaust pipe 102 is arranged at an upper end of the generator 100. The condenser 200has a condensation cavity 201, and an inlet of the condensation cavity 201 is communicated with the exhaust pipe 102. The evaporator 300 has an evaporation cavity 301, and an inlet of the evaporation cavity 301 is communicated with an outlet of the condensation cavity 201 through a liquid inlet pipe 302. The expansion valve 400 is arranged on the liquid inlet pipe 302. The absorber 500 is located below the generator 100 and has an absorption cavity 501 for containing a sodium nitrate solution. An upper part of the absorption cavity 501 is communicated with an outlet of the evaporation cavity 301 through a gas pipe 502. The absorber 500 is provided with a liquid delivery pipe 503 and a reflux pipe 504. An upper end of the liquid delivery pipe 503 is communicated with the liquid storage cavity 101, and a lower end of the liquid delivery pipe 503 is communicated with the upper part of the absorption cavity 501. An upper end of the reflux pipe 504 is communicated with the liquid storage cavity 101, and a lower end of the reflux pipe 504 extends to a lower part of the absorption cavity 501 and is located below a liquid level of the sodium nitrate solution in the absorption cavity 501. A reflux pump 505 is arranged on the reflux pipe 504. A first cold water pipe 601 and a second cold water pipe 602 are arranged at a cold water output end of the lithium bromide-water refrigerating machine 600. The first cold water pipe 601 is connected to the condenser 200 to cool a gas in the condensation cavity 201, and the second cold water pipe 602 is connected to the absorber 500 to cool the sodium nitrate solution in the absorption cavity 501. It is understood that the lithium bromide-water refrigerating machine 500 belongs to the existing technology, which will not be repeated here. The lithium bromide-water refrigerating machine 500 can produce cold water having a temperature of 7° C. for cooling the condenser 200 and the absorber 400.

Referring to FIG. 1, an operating process of the refrigeration system is as follows. The heat source 110 is used to heat the liquid ammonia and sodium nitrate solution in the liquid storage cavity 101. The liquid ammonia evaporates into ammonia gas when heated, and the ammonia gas moves upward through the exhaust pipe 102 into the condenser 200 and exchanges heat with the cold water in the first cold water pipe 501 in the condenser 200 to be condensed into liquid ammonia. Then, the liquid ammonia flows into the liquid inlet pipe 302, changes from high temperature and high pressure to low temperature and low pressure after passing through the expansion valve 400, enters the evaporation cavity 301 of the evaporator 300, and evaporates in the evaporation cavity 301 into ammonia gas while absorbing heat from the surrounding environment, thereby realizing refrigeration. After that, the ammonia gas rises and enters the gas pipe 502. Since the gas pipe 502 is communicated to the absorption cavity 501, the ammonia gas is absorbed by the sodium nitrate solution in the absorption cavity 501. In order to ensure the ability of the sodium nitrate solution to absorb the ammonia gas, the cold water in the second cold water pipe 502 is used to reduce the temperature of the sodium nitrate solution in the absorption cavity 401. The sodium nitrate solution that has absorbed the ammonia gas is pumped to the liquid storage cavity 101 through the reflux pump 505, and part of the sodium nitrate solution (the liquid ammonia has been evaporated by heating) in the liquid storage cavity 101 enters the absorption cavity 501 through the liquid delivery pipe 503 to form a circulation. The refrigeration system uses sodium nitrate as an absorbent and liquid ammonia as a refrigerant, where sodium nitrate is a kind of salt with a boiling point of 380° C., which is very different from a boiling point of liquid ammonia, such that rectification equipment is eliminated, the system is simplified, and the cost is reduced. The constant-pressure specific heat is relatively large, which is beneficial to reduce a heat exchange area, miniaturize the equipment and reduce the occupied space. Liquid ammonia-sodium nitrate is an ideal working pair for absorption and refrigeration, and its COP can also meet higher requirements. The refrigeration can reach a temperature below zero to meet the larger refrigeration demand and provide a wider range of applications.

Referring to FIG. 1, according to some embodiments of the present invention, the heat source 110 is a hot water pipeline has a temperature of 110° C. or higher. For example, an oil refinery workshop in the petrochemical industry can produce a large amount of steam condensate having a temperature of 120° C. per hour, while a dewaxing process in the oil refinery workshop requires refrigeration (the refrigeration temperature is −40° C. and −20° C.), and thus the refrigeration system of the present invention can be used.

Referring to FIG. 1, according to some embodiments of the present invention, a pressure pump is arranged on the hot water pipeline, such that the flow rate is increased and the heating capability is improved.

Referring to FIG. 1, according to some embodiments of the present invention, the first cold water pipe 601 is provided with a coil in the condensation cavity 201 where the coil and the liquid inlet pipe 302 exchange heat. The coil increases a contact area and improves the capability to cool the ammonia gas.

Referring to FIG. 1, according to some embodiments of the present invention, the expansion valve 400 is an electronic expansion valve 400, such that the control accuracy and the refrigeration efficiency can be improved.

Referring to FIG. 1, according to some embodiments of the present invention, the liquid delivery pipe 503 and the reflux pipe 504 are arranged at two ends of the absorber 500 separately to reduce mutual influences.

Referring to FIG. 1, according to some embodiments of the present invention, one end of the exhaust pipe 102 connected to the condensation cavity 201 is configured to be bent upward, such that the sodium nitrate solution carried in the ammonia gas flows back to the liquid storage cavity 101.

Referring to FIG. 1, according to some embodiments of the present invention, a middle part of the gas pipe 502 is configured to bulge upward, such that the ammonia gas can be prevented from carrying the liquid ammonia into the absorption cavity 501.

Referring to FIG. 1, according to some embodiments of the present invention, the lithium bromide-water refrigerating machine 600 includes a second generator 610, which is connected to the heat source 110 to realize heating. The second generator 610 and the generator 100 share a common heat source to simplify the structure and improve the efficiency.

Referring to FIG. 1, according to some embodiments of the present invention, cold water output from the lithium bromide-water refrigerating machine 600 has a temperature of 7° C. to 9° C.

The embodiments of the present invention are described in detail above with reference to the accompanying drawings. However, the present invention is not limited to the above-mentioned embodiments, and various changes can be made without departing from the purpose of the present invention within the scope of knowledge possessed by those having ordinary skills in the art.

We claim:

1. A refrigeration system, comprising:
a generator having a liquid storage cavity for containing a liquid ammonia and sodium nitrate solution, wherein a heat source is connected to the generator, and an exhaust pipe is arranged at the upper end of the generator;
a condenser having a condensation cavity, wherein an inlet of the condensation cavity is communicated with the exhaust pipe;
an evaporator having an evaporation cavity, wherein an inlet of the evaporation cavity is communicated with an outlet of the condensation cavity through a liquid inlet pipe;
an expansion valve arranged on the liquid inlet pipe;
an absorber located below the generator and having an absorption cavity for containing a sodium nitrate solution, wherein an upper part of the absorption cavity is communicated with an outlet of the evaporation cavity through a gas pipe; the absorber is provided with a liquid delivery pipe and a reflux pipe, an upper end of the liquid delivery pipe is communicated with the liquid storage cavity and a lower end of the liquid delivery pipe is communicated with a upper part of the absorption cavity; an upper end of the reflux pipe is communicated with the liquid storage cavity, and a lower end of the reflux pipe extends to a lower part of the absorption cavity; and a reflux pump is arranged on the reflux pipe; and
a lithium bromide-water refrigerating machine, wherein a first cold water pipe and a second cold water pipe are arranged at a cold water output end of the lithium bromide-water refrigerating machine, the first cold water pipe being connected to the condenser to cool a gas in the condensation cavity, and the second cold water pipe being connected to the absorber to cool the sodium nitrate solution in the absorption cavity.

2. The refrigeration system of claim 1, wherein the heat source is a hot water pipeline has a temperature of 110° C. or higher.

3. The refrigeration system of claim 2, wherein a pressure pump is provided on the hot water pipeline.

4. The refrigeration system of claim 1, wherein the first cold water pipe is provided with a coil in the condensation cavity where the coil and the liquid inlet pipe exchange heat.

5. The refrigeration system of claim 1, wherein the expansion valve is an electronic expansion valve.

6. The refrigeration system of claim 1, wherein the liquid delivery pipe and the reflux pipe are arranged at two ends of the absorber separately.

7. The refrigeration system of claim 1, wherein one end of the exhaust pipe connected to the condensation cavity is configured to be bent upward.

8. The refrigeration system of claim 1, wherein a middle part of the gas pipe is configured to bulge upward.

9. The refrigeration system of claim 1, wherein the lithium bromide-water refrigerating machine comprises a second generator, which is connected to the heat source to realize heating.

10. The refrigeration system of claim 9, wherein cold water output from the lithium bromide-water refrigerating machine has a temperature of 7° C. to 9° C.
